(19) United States
(12) Patent Application Publication
(10) Pub. No.: US 2026/0252631 A1
(43) Pub. Date: Aug. 27, 2026

(54) CLUSTERING SUPPORT SYSTEM, METHOD, AND PROGRAM

(71) Applicant: NEC Corporation, Minato-ku, Tokyo (JP)

(72) Inventors: Noritaka YAMASHITA, Tokyo (JP); Yasuhiro MIZUKOSHI, Tokyo (JP); Norihito OI, Tokyo (JP); Asako FUJII, Tokyo (JP)

(73) Assignee: NEC Corporation, Minato-ku, Tokyo (JP)

(21) Appl. No.: 18/879,284

(22) PCT Filed: Sep. 27, 2022
(86) PCT No.: PCT/JP2022/035834

§ 371 Date: Dec. 27, 2024

(51) Int. Cl. G06F 16/904; G06F 16/906; G06T 11/26

(52) U.S. Cl. CPC G06F 16/904; G06F 16/906; G06T 11/26

(57) ABSTRACT

The classification means 181 generates multiple clusters by classifying the target data through machine learning. The display means 182 displays the target data included in the generated clusters in a predetermined style at a corresponding position on a graph according to feature of the target data. During the display, the display means 182 changes the style in which the target data is displayed on the graph according to the numerical information for each feature.

### TECHNICAL FIELD

The present invention relates to a clustering support system, clustering support method, and clustering support program for supporting data clustering.

### BACKGROUND ART

In the Internet of Things (IoT) era, it has become possible to collect data from various devices. The classification of data is essential for tasks such as data searches and artificial intelligence (AI) learning using the vast amounts of data collected.

Various methods have been proposed to support the classification of data. For example, Patent Literature 1 describes a teacher data generation system that makes the generation of teacher data more efficient. The system described in the Patent Literature 1 clusters action histories and presents the contents of some of the action histories belonging to a cluster to the analyst to specify a label. The above system then assigns the specified labels to the data in the cluster and generates the teacher data.

### CITATION LIST

### Patent Literature

PL 1: Patent Publication No. 2021-56591

### SUMMARY OF INVENTION

### Technical Problem

The method described in Patent Literature 1 allows for understanding a set of data with similar characteristics by clustering it. However, when there are many types of characteristics (data items), it is generally difficult to understand which data items contributed to the clustering.

In the system described in Patent Document 1, the contents of some of the action histories belonging to a cluster are presented to the analyst to specify a label. However, if the action history contains many types of data items, it is difficult to determine the label to be specified from the contents. Therefore, even if a label is assigned in such a situation, it may be unclear what the cluster means (i.e., why it was classified that way).

Therefore, it is an exemplary objective of this invention to provide a clustering support system, clustering support method, and clustering support program that supports understanding of features that contributed to the clustering of the target data.

### Solution to Problem

The clustering support system according to the present invention includes a classification means for generating multiple clusters by classifying target data through machine learning, and a display means for displaying the target data included in the generated clusters in a predetermined style at a corresponding position on a graph according to feature of the target data, wherein the display means changes the style in which the target data is displayed on the graph according to the numerical information for each feature.

The clustering support method according to the present invention includes: generating multiple clusters by classifying target data through machine learning; and displaying the target data included in the generated clusters in a predetermined style at a corresponding position on a graph according to feature of the target data, wherein, in displaying the target, the display style in which the target data is displayed on the graph is changed according to the numerical information for each feature.

The clustering support program according to the present invention for causing a computer to execute: a classification process for generating multiple clusters by classifying target data through machine learning; and a display process for displaying the target data included in the generated clusters in a predetermined style at a corresponding position on a graph according to feature of the target data, wherein, in the display process, the display style in which the target data is displayed on the graph is changed according to the numerical information for each feature.

### Advantageous Effects of Invention

According to the present invention, it becomes possible to support understanding of data items that contributed to the clustering.

### BRIEF DESCRIPTION OF DRAWINGS

FIG. 1 It depicts a block diagram showing a configuration example of one example embodiment of the clustering support system according to the present invention.

FIG. 2 It depicts an explanatory diagram showing an example of the data used in the clustering support system.

FIG. 3 It depicts an explanatory diagram showing an example of features.

FIG. 4 It depicts an explanatory diagram showing an example of visualizing dimension-reduced data in a graph.

FIG. 5 It depicts an explanatory diagram showing another example of visualizing dimension-reduced data in a graph.

FIG. 6 It depicts an explanatory diagram showing an example of changing the display style on the graph according to the numerical information for each feature.

FIG. 7 It depicts an explanatory diagram showing an example of displaying correlations between features.

FIG. 8 It depicts an explanatory diagram showing an example process of recalculating statistical quantities by specifying data to be classified on the graph.

FIG. 9 It depicts a flowchart showing an example of the operation of the clustering support system.

FIG. 10 It depicts a block diagram showing the outline of the clustering support system according to the present invention.

FIG. 11 It depicts a summarized block diagram showing the configuration of a computer for at least one example embodiment of the present invention.

### DESCRIPTION OF EMBODIMENTS

The following is an explanation of the example embodiments of the present invention with reference to the drawings. In the following description, videos (image data) are exemplified as an example of the data to be classified. However, the data to be classified is not limited to videos; for example, it could be still images, music data, text data, or other forms. The data to be classified may be labeled or unlabeled.

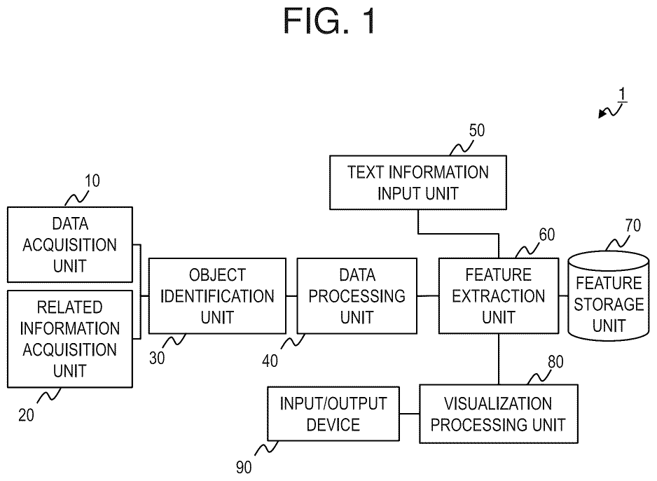

FIG. 1 is a block diagram showing the configuration example of one example embodiment of the clustering support system according to the present invention. The clustering support system 1 of the present example embodiment includes a data acquisition unit 10, a related information acquisition unit 20, an object identification unit 30, a data processing unit 40, a text information input unit 50, a feature extraction unit 60, a feature storage unit 70, a visualization processing unit 80, and an input/output device 90.

The data acquisition unit 10 acquires the data to be classified, i.e., the data to be clustered. For example, if a camera (not shown) captures an image of an animal, the data acquisition unit 10 may acquire the video of the animal captured by the camera as the data to be classified. The data acquired by the data acquisition unit 10 is not limited to data acquired in real time. The data acquisition unit 10 may, for example, acquire the data to be classified from a storage server (not shown) where the data to be classified is stored.

The related information acquisition unit 20 acquires information related to the data to be classified (hereinafter referred to as “related information”). In this example embodiment, the related information is information indicating the conditions under which the data was generated. For example, this could include information representing the location or time at which the data was generated (such as where it was captured) or data acquired from sensors (hereinafter referred to as “sensor data”).

For example, if video data showing the operation status of a thermal power plant is used as the data to be classified, sensor data may include the flow rate of fuel, pressure, temperature, rotational speed, and power generation amount. Similarly, if video data showing the state of a farm is used as the data to be classified, sensor data may include information such as time, temperature, humidity, pH, soil moisture content, solar radiation, wind direction and speed, and water level.

If the data to be classified is video data captured by an in-vehicle camera (dashcam), the related information may include GPS (Global Positioning System) information representing the vehicle's position, as well as information acquired based on the CAN (Controller Area Network). Examples of sensor data acquired in this case include speed, acceleration, and position (latitude, longitude, altitude).

The object identification unit 30 identifies objects included in the acquired data and generates information (hereinafter referred to as “object list”) that specifies the identified objects. For example, if the object to be identified is a vehicle, the object identification unit 30 may identify the vehicle from the data acquired by the data acquisition unit 10 and generate information specifying the vehicle (such as coordinates indicating its position in the image) as the object list. Well-known methods exist for identifying objects from images or videos, so detailed explanations are omitted here.

The data processing unit 40 processes the data (more specifically, the object list) so that it can be used by the feature extraction unit 60 in the subsequent processing. Specifically, the data processing unit 40 processes the data to improve the accuracy of feature extraction or clustering. The data processing unit 40 may, for example, perform operations such as data thinning, interpolation of missing values, removal of outliers, and deletion of unnecessary data items. If the data to be classified is video data, the data processing unit 40 may convert the video data into numerical time series data.

The data processing unit 40 may also process data based on multiple sources of data. For example, in the case of video data, the data processing unit 40 may process data using multiple sampling data sources. In the following explanation, data or data items processed based on multiple data sources may be referred to as “statistical quantities.”

For example, based on 1-second sampling data, the data processing unit 40 may calculate statistical quantities using 5 seconds' worth of data. The content of the calculated statistical quantities is arbitrary. The data processing unit 40 may calculate the average value of the data over 5 points, or it may identify the maximum or minimum values, median, first data point (1st second), or last data point (5th second). Additionally, the data processing unit 40 may calculate differences such as the difference between the maximum and minimum values or the difference between the first data point (1st second) and last data point (5th second).

The data processing unit 40 may also calculate statistical quantities using predefined formulas. For example, if the data to be classified includes speed and acceleration, the data processing unit 40 may calculate a statistical quantity based on a formula such as “statistical quantity=speed*5+acceleration*2-100”.

Furthermore, the data processing unit 40 may calculate statistical quantities based on known conversion formulas. Examples of conversion formulas include formulas for converting between vehicle direction data and yaw rate or between speed and acceleration in automotive data.

In this example embodiment, the data processing unit 40 is illustrated as performing the statistical quantity calculation, but the visualization processing unit 80 described below may calculate the statistical quantities before visualization processing.

The text information input unit 50 receives input of text data including additional information (hereinafter referred to as “additional information”) that is appended to each classified data item. The additional information is information indicating the contents of the data to be classified that can be acquired other than the related information. Examples of a category indicating additional information include weather, plant types, and subjects. Weather category values may include “sunny”, “cloudy”, “rain”, and “snow”; plant type category values may include “rice”, “wheat”, and “barley”; and subject examples may include “dog”, “cat”, “person”, “car”, and “bicycle”.

The input of text data is optional. That is, the data to be classified may not have any additional information appended. However, since the classification accuracy improves with more additional information, it is preferable that additional information is input. In the following explanation, the data to be classified with additional information appended will also be referred to simply as “the data to be classified.”

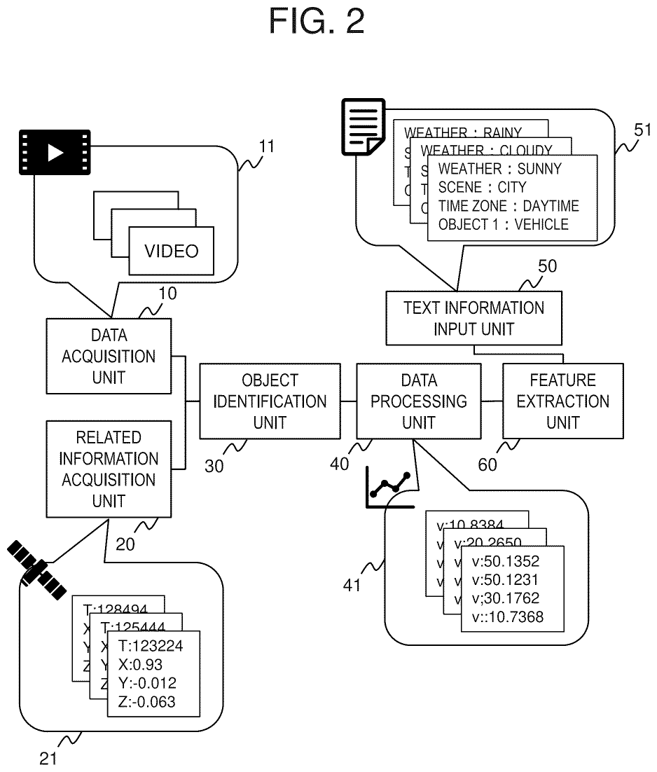

FIG. 2 is an explanatory diagram showing an example of the data used by the clustering support system 1 of the present example embodiment. In the example shown in FIG. 2, the data acquisition unit 10 acquires video 11 as data to be classified, and the related information acquisition unit 20 acquires related information 21 concerning the location where video 11 was captured. The example shown in FIG. 2 also shows that the data processing unit 40 processes the video 11 and related information 21 (specifically, the object list generated by the object identification unit 30) to generate numerical time series data 41. Furthermore, the example shown in FIG. 2 show that the text information input unit 50 receives input of text data 51 including additional information on weather, scenes, time zones, and objects.

The feature extraction unit 60 extracts features from each classified data item. The feature extraction unit 60 of the present example embodiment generates multiple clusters by automatically classifying the data to be classified, including the additional information, through machine learning. The method used for clustering through machine learning is arbitrary and may be supervised or unsupervised learning. Examples of unsupervised learning include methods such as k-means and Gaussian mixture models.

The feature extraction unit 60 extracts the features of each data included in the generated clusters. For example, the feature extraction unit 60 may extract, as features, the additional information included in the text data, data items, or calculated statistical quantities. Additionally, the feature extraction unit 60 may extract features represented by numerical time series data. Specifically, the feature extraction unit 60 may extract features based on information included in the data to be classified (more specifically, numerical time series data), such as sensor values.

The method for extracting features from numerical time series data is arbitrary. For example, in the case of clusters generated using the k-means method, the feature extraction unit 60 may extract features called a distance from the center of gravity of the numerical time series data included in the cluster to each piece of data (cluster distance feature).

In this way, the feature extraction unit 60 performs classification processing of the data to be classified through unsupervised learning or other methods, functioning as a classification means. In this example embodiment, it has been described how the object identification unit 30 identifies objects from the information acquired by the data acquisition unit 10 and the related information acquisition unit 20, and how the data processing unit 40 processes the data for use by the feature extraction unit 60. However, the data acquisition unit 10 may directly acquire data in a format that the feature extraction unit 60 can use, and input the acquired data into the feature extraction unit 60. In this case, the clustering support system 1 does not need to include the related information acquisition unit 20, the object identification unit 30, or the data processing unit 40.

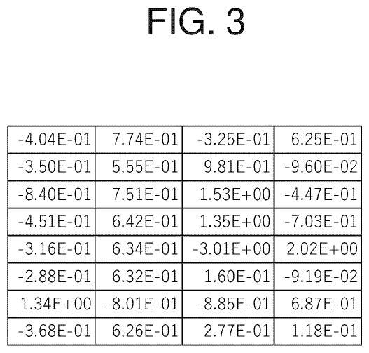

The feature storage unit 70 stores the features extracted by the feature extraction unit 60 for each classified data item. The method by which the feature storage unit 70 stores features for each classified data item is arbitrary. FIG. 3 is an explanatory diagram showing an example of the features stored by the feature storage unit 70. In the example shown in FIG. 3, the vertical axis represents one feature point, and the horizontal axis represents the features (category values) for each category (e.g., weather, subject, plant type). The feature storage unit 70 is realized, for example, through a magnetic disk or similar device.

The visualization processing unit 80 performs processing to visualize the data to be classified on a graph. The data to be classified generally includes multiple features. Therefore, the visualization processing unit 80 displays the data to be classified by drawing a graph on the input/output unit 90 with a dimensional reduction (lower dimension) of the data to be classified so that humans can observe how the data has been clustered.

In this context, dimensional reduction refers to the process of converting high-dimensional data, where each dimension represents a feature included in the data to be classified, into low-dimensional data while retaining as much important information as possible. Examples of dimensional reduction methods include PCA (Principal Component Analysis), t-SNE (t-distributed Stochastic Neighbor Embedding), and UMAP (Uniform Manifold Approximation and Projection).

The visualization processing unit 80 may, for example, use UMAP described above to perform dimensional reduction of the data to be classified into two or three dimensions and visualize the dimension-reduced data as a scatter plot or similar graph.

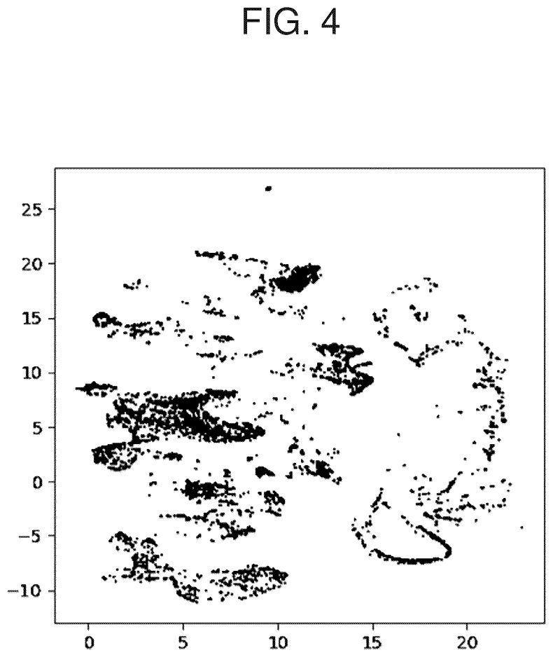

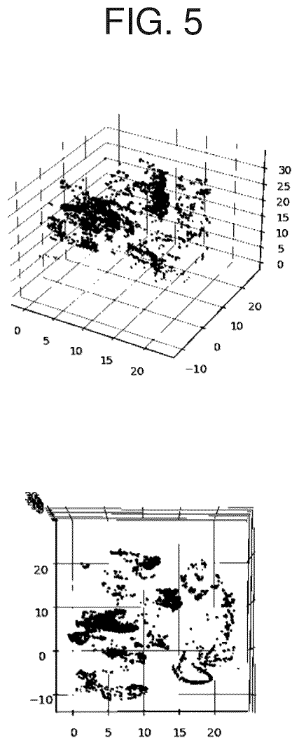

FIG. 4 is an explanatory diagram showing an example of visualizing dimension-reduced data in a graph. The graph illustrated in FIG. 4 shows an example where the data to be classified reduced to two dimensions using UMAP is displayed as a collection of points. FIG. 5 is an explanatory diagram showing another example of visualizing dimension-reduced data in a graph. The graph illustrated in FIG. 5 shows an example where the data to be classified reduced to three dimensions using UMAP is displayed as a collection of points.

Additionally, the visualization processing unit 80 may display the features and statistical quantities of the data to be classified, which are specified by the user via the input/output device 90, separately from the graph. When multiple data to be classified are specified, the visualization processing unit 80 may display the features and statistical quantities of all specified data to be classified. The display method is arbitrary, and the visualization processing unit 80 may display each piece of information side by side or make the display switchable.

By displaying multiple pieces of information in this manner, it becomes possible to confirm how the features differ between different data items within the same cluster (e.g., the left and right sides of the cluster) or between data items in different clusters.

On the other hand, while the graph visualized through dimensionality reduction makes it easy to understand the clustering state of the data to be classified, it may be difficult to understand the meaning of each cluster (i.e., why the data was classified in that way). Therefore, in this example embodiment, the visualization processing unit 80 displays the target data included in the generated clusters on the input/output device 90 in a predetermined style at a corresponding position on a graph according to feature of the target data. Predetermined display styles include points or symbols. Furthermore, in this example embodiment, the visualization processing unit 80 changes the display style on the graph according to the numerical information of each feature. Since the data to be classified generally includes multiple features, the target features are selected by the user via the input/output device 90. The numerical information of features in this example embodiment includes not only directly obtainable values such as “speed” or “acceleration” but also values that can be obtained based on the features, such as “vehicle orientation” (e.g., angles). Furthermore, the numerical information of the features includes the respective data from which the features are extracted (i.e. the respective data to be classified input into the feature extraction unit 60), the feature obtained from the feature extraction unit 60 before the visualization process and the statistical quantities calculated using the respective data to be classified.

Methods for changing the display style according to the numerical information of features include changing the color density or brightness. However, the method for changing is not limited to color density or brightness changes. The visualization processing unit 80 may, for example, change the size of the displayed style (e.g. the size of the dots) or change the style itself (e.g. change the symbol itself) according to the numerical information of the features.

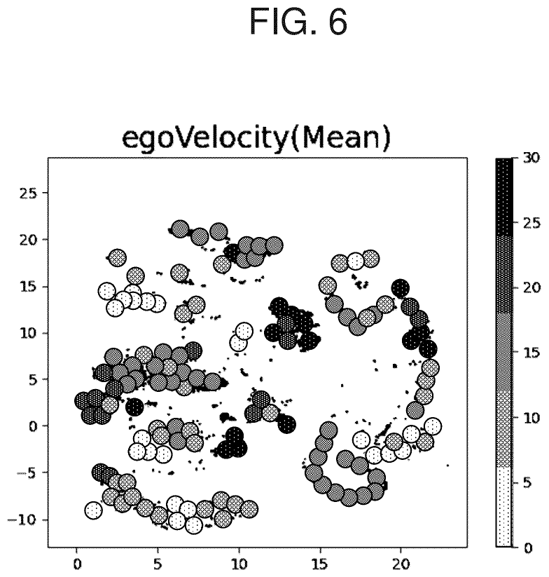

FIG. 6 is an explanatory diagram showing an example of changing the display style on the graph according to the numerical information of each feature. The example in FIG. 6 shows a graph in which the shading density has been changed according to the numerical information of a specified feature (e.g., the average vehicle speed) for the graph shown in FIG. 4. The graph in FIG. 6 is an enlarged display of several sampled points from the graph shown in FIG. 4 for illustrative purposes. For ease of display, the bar shown on the right side of the graph in FIG. 6 are divided into ranges with varying shades of shading, but it is preferable to display a gradient of shading in correspondence with the values.

As shown in FIG. 6, since the graph is displayed according to the feature (e.g., average vehicle speed), the graph shown in FIG. 6 can be considered a graph showing the distribution of the average vehicle speed. For example, if the numerical information of the feature is represented by shading density, color shades can be distinguished by clusters, it can be judged that the feature has significantly influenced the clustering. Conversely, if there is no distinction in shading density, it can be judged that the feature has little influence on the clustering.

The visualization processing unit 80 may automatically make such judgments. The visualization processing unit 80 may, for example, identify a set of data to be classified including a cluster from the displayed graph, and calculate statistical quantities such as mean values and variances for the pixel values (shading) of pixels indicating the identified data to be classified. In this case, for example, if the mean value is smaller than a predetermined value and the variance is smaller than a predetermined value, the visualization processing unit 80 may determine that many values with small pixel values are clustered together and that the features contribute to clustering.

The above explanation also describes a case where the input/output device 90 receives a single feature specified by the user, and the visualization processing unit 80 changes the display style on the graph according to the numerical information of the feature. However, the specified feature may not be limited to just one; multiple features may be specified. If multiple features are specified, the visualization processing unit 80 may change the display style on the graph according to the numerical information of two or more features simultaneously.

Specifically, the visualization processing unit 80 may display graphs that change the display style for each numerical information of the specified features. In this case, the visualization processing unit 80 may display the graphs in parallel or switch between them.

Additionally, the visualization processing unit 80 may display the numerical information of two or more features on a single graph at the same time. For example, the visualization processing unit 80 may decide the color for each feature, determine the shading for each color based on the numerical information of the features, and display the determined colors overlapped as a mixed-color display.

The colors used for mixed-color display may be predefined. For example, assuming that three or so colors are mixed and displayed, independent colors of light (e.g., red, green, and blue) may be predefined, and the visualization processing unit 80 may display a mixture of these colors (e.g., cyan, magenta, and yellow).

The method for displaying the numerical information of two or more features on a single graph is not limited to mixed-color display. The visualization processing unit 80 may also display the data to be classified based on a combination of symbol size and color shading or pattern.

Furthermore, when two or more features are specified, the visualization processing unit 80 may display the data to be classified by changing the style of features based on the correlation or similarity between the specified features. For example, when one feature is selected out of two or more specified features, the visualization processing unit 80 may change the display style of the remaining features based on the strength of the correlation between one selected feature and the other remaining features.

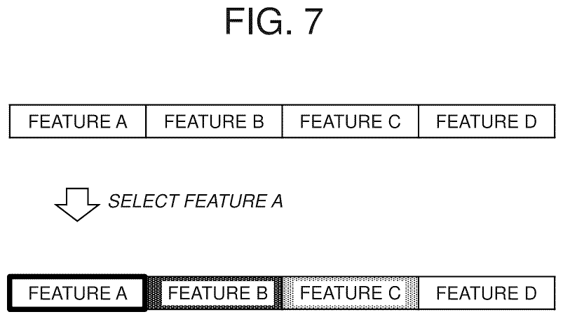

FIG. 7 is an explanatory diagram showing an example of displaying the correlation between features. The example shown in FIG. 7 shows an example where feature A, feature B, feature C and feature D are specified, and when feature A is selected, the visualization processing unit 80 changes the shaded display of the other remaining feature values B to D according to the strength of the correlation with feature A.

The method for displaying correlations is not limited to shading as shown in FIG. 7. The visualization processing unit 80 may, for example, display the features in a specified color (e.g., red for strong correlation, blue for weak correlation) instead of using shading.

Furthermore, the visualization processing unit 80 may recalculate statistical quantities for a specified range of data to be classified on the displayed graph and change the display style of the data to be classified in the specified range according to the recalculated statistical quantities. For example, the visualization processing unit 80 may recalculate the average value of the features for the data to be classified in the specified range and change the display style according to the recalculated average value. In this case, the visualization processing unit 80 may redraw the graph to show only the data to be classified within the specified range or change the display style of the data to be classified only within the specified range.

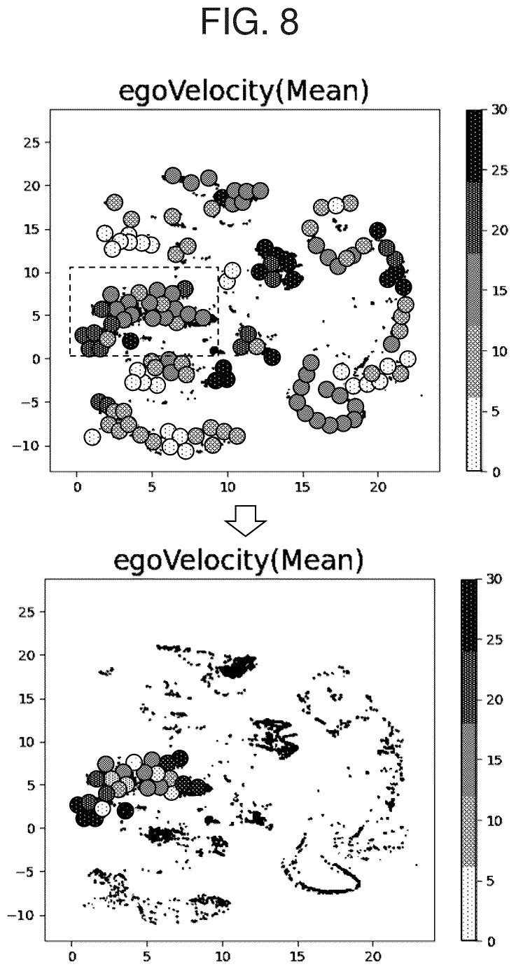

FIG. 8 is an explanatory diagram showing an example process of recalculating statistical quantities by specifying data to be classified on the graph. The example shown in FIG. 8 shows an example of specifying the data to be classified in the range indicated by the dashed line from the graph illustrated in FIG. 6, and displaying the results of recalculating the statistical quantities within that specified range. As illustrated in FIG. 8, by specifying a range and recalculating, it becomes possible to understand the detailed distribution of data within a cluster, for example.

Additionally, the visualization processing unit 80 may recalculate multiple statistical quantities for the specified range of data to be classified. The visualization processing unit 80 may receive specification of multiple statistics and simultaneously display the received multiple statistical quantities on a single graph, or may change the style in which the features are displayed based on the correlation or similarity of the specified statistics.

By displaying data to be classified in the specified range, it becomes possible to confirm the data distribution within a cluster or nearby clusters, as well as to display statistical quantities and correlations between data within a specified range.

The input/output device 90 displays the results of the processing by the visualization processing unit 80. Additionally, the input/output device 90 receives user input based on the displayed results and executes processing in the visualization processing unit 80 according to the input. The input/output device 90 may be realized by a tablet device, for example. Alternatively, the input/output device 90 may be realized by a display device and a device with a pointing device.

The data acquisition unit 10, the related information acquisition unit 20, the object identification unit 30, the data processing unit 40, the text information input unit 50, the feature extraction unit 60, and the visualization processing unit 80 are all realized by a computer processor (such as a CPU) that operates in accordance with a program (clustering support program).

For example, the program may be stored in the memory unit (not shown) of the clustering support system 1, and the processor may read the program and execute it according to the instructions to function as the data acquisition unit 10, the related information acquisition unit 20, the object identification unit 30, the data processing unit 40, the text information input unit 50, the feature extraction unit 60, and the visualization processing unit 80. Additionally, the functionality of the clustering support system 1 may be provided as a Saas (Software as a Service).

The data acquisition unit 10, the related information acquisition unit 20, the object identification unit 30, the data processing unit 40, the text information input unit 50, the feature extraction unit 60, and the visualization processing unit 80 may be implemented by dedicated hardware. Alternatively, part or all of the components of each device may be implemented by a combination of general-purpose or dedicated circuits, processors, or similar hardware. These components may be configured on a single chip or on multiple chips connected via a bus. Some or all of the components of each device may be realized by a combination of the above-mentioned circuits and programs.

Furthermore, when part or all of the components of the clustering support system 1 are implemented using multiple information processing devices or circuits, the multiple information processing devices or circuits may be centrally or distributedly arranged. For example, the information processing device, the circuitry, etc. may be realized as a client-server system, a cloud computing system, etc., each of which is connected via a communication network.

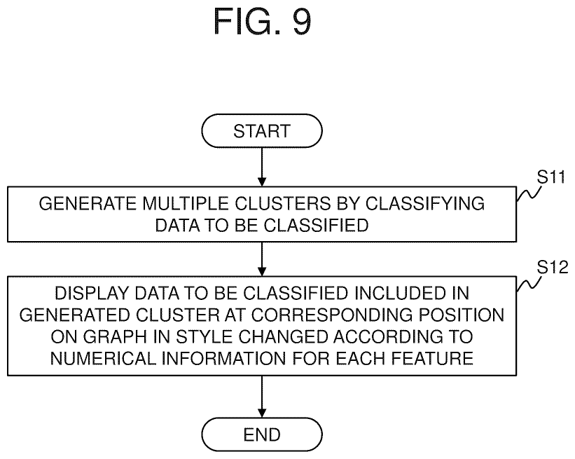

Next, the operation of the clustering support system 1 of this example embodiment will be described. FIG. 9 is a flowchart showing an example of the operation of the clustering support system 1. The operational example shown in FIG. 9 illustrates the case where the data acquisition unit 10 directly acquires data in a format usable by the feature extraction unit 60 and inputs the acquired data into the feature extraction unit 60.

The feature extraction unit 60 generates multiple clusters by classifying the data to be classified through machine learning (Step S11). The visualization processing unit 80 displays the data to be classified included in the generated clusters at corresponding positions on the graph in a style changed according to the numerical information for each feature (Step S12).

As described above, in this example embodiment, the feature extraction unit 60 generates multiple clusters by classifying data to be classified through machine learning, and the visualization processing unit 80 displays the data to be classified included in the generated clusters in a predetermined style at a corresponding position on a graph according to the feature of the data to be classified. Then, the visualization processing unit 80 changes the style in which the data to be classified is displayed on the graph according to the numerical information for each feature. In this configuration, it becomes possible to support understanding of the data items that contributed to the clustering.

For example, simply using AI to classify data into clusters often leaves the reasons for classification unclear. In such cases, a common approach involves manually reviewing the data or video to find common points subjectively. However, checking all data manually or using spreadsheet software is not practical, and the reasons for clustering are usually determined based on a sample of the data. This approach, however, heavily depends on the sampled data, making it difficult to appropriately determine the reasons for clustering.

In contrast, in this example embodiment, the visualization processing unit 80 displays a list of the target to be classified included in the generated clusters in a graph in a style changed according to the numerical information for each feature. Therefore, the data distribution can be viewed at a glance for each feature, making it easy to understand which data items contributed to clustering.

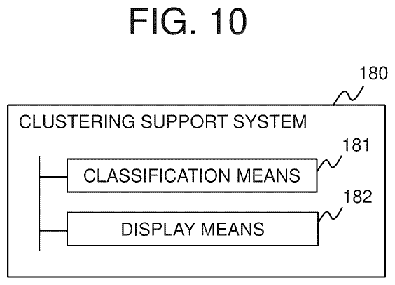

Next, the outline of the present invention will be explained. FIG. 10 is a block diagram showing the outline of the clustering support system according to the present invention. The clustering support system 180 (for example, the clustering support system 1) according to the present invention includes a classification means 181 (for example, the feature extraction unit 60) for generating multiple clusters by classifying target data through machine learning, and a display means 182 (for example, the visualization processing unit 80) for displaying the target data included in the generated clusters in a predetermined style at a corresponding position on a graph according to feature of the target data.

The display means 182 changes the style in which the target data is displayed on the graph according to the numerical information for each feature.

This configuration supports understanding the data items that contributed to the clustering.

Additionally, the display means 182 may display the target data by changing change the style so as to simultaneously show the numerical information of two or more features.

Specifically, the display means 182 may overlap colors indicated by the numerical information of each feature and displays mixed colors.

The display means 182 may change shading density or brightness of the style according to the numerical information.

The display means 182 may recalculate statistical quantities of the target data for a specified range on the displayed graph and change the style in which classification target data in the specified range is displayed on the graph according to the recalculated statistical quantities.

The display means 182 may display the target data by changing the style of the feature based on correlation between specified features.

The display means 182 may display the target data on the graph by performing dimensional reduction (for example, reduced to 2D or 3D).

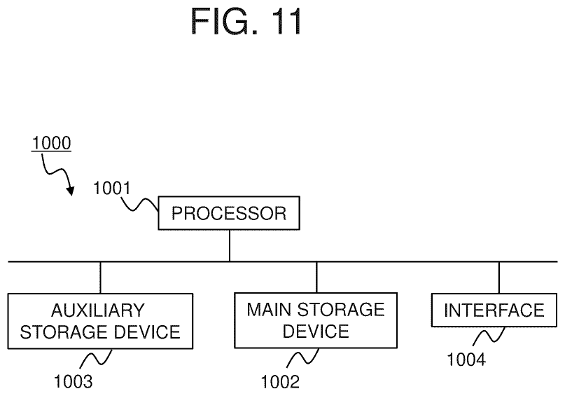

FIG. 11 is a summarized block diagram showing a configuration of a computer for at least one example embodiment. The computer 1000 includes a processor 1001, a main storage device 1002, an auxiliary storage device 1003, and an interface 1004.

The clustering support system 80 described above is implemented in a computer 1000. The operation of each of the above described processing parts is stored in the auxiliary storage device 1003 in the form of a program (clustering support program). The processor 1001 reads the program from the auxiliary storage device 1003, loads it into the main storage device 1002, and executes the above described processing according to the program.

In at least one example embodiment, the auxiliary storage device 1003 is an example of a non-transitory tangible medium. Other examples of a non-transitory tangible medium include a magnetic disk, an optical magnetic disk, a CD-ROM (Compact Disc Read-only memory), a DVD-ROM (Read only memory), semiconductor memory, and the like connected via the interface 1004. When the program is delivered to the computer 1000 through a communication line, the computer 1000 receiving the delivery may load the program into the main storage device 1002 and execute the above processing.

The program may be a program for realizing a part of the above described functions. Further, the program may be a so-called difference file (difference program) that realizes the aforementioned functions in combination with other programs already stored in the auxiliary storage device 1003.

A part of or all of the above example embodiments may also be described as, but not limited to, the following supplementary notes.

### Supplementary Note 1

A clustering support system comprising:
a classification means for generating multiple clusters by classifying target data through machine learning; and
a display means for displaying the target data included in the generated clusters in a predetermined style at a corresponding position on a graph according to feature of the target data,
wherein the display means changes the style in which the target data is displayed on the graph according to the numerical information for each feature.

### Supplementary Note 2

The clustering support system according to Supplementary note 1, wherein
the display means displays the target data by changing the style so as to simultaneously show the numerical information of two or more features.

### Supplementary Note 3

The clustering support system according to Supplementary note 2, wherein
the display means overlaps colors indicated by the numerical information of each feature and displays mixed colors.

### Supplementary Note 4

The clustering support system according to any of Supplementary notes 1 to 3, wherein
the display means changes shading density or brightness of the style according to the numerical information.

### Supplementary Note 5

The clustering support system according to any of Supplementary notes 1 to 4, wherein
the display means recalculates statistical quantities of the target data for a specified range on the displayed graph and changes the style in which the classification target data in the specified range is displayed on the graph according to the recalculated statistical quantities.

### Supplementary Note 6

The clustering support system according to any one of Supplementary notes 1 to 5, wherein
the display means displays the target data by changing the style of the feature based on correlation between specified features.

### Supplementary Note 7

The clustering support system according to any one of Supplementary notes 1 to 6, wherein
the display means displays the target data on the graph by performing dimensional reduction.

### Supplementary Note 8

A clustering support method comprising:
generating multiple clusters by classifying target data through machine learning; and
displaying the target data included in the generated clusters in a predetermined style at a corresponding position on a graph according to feature of the target data,
wherein, in displaying the target, the display style in which the target data is displayed on the graph is changed according to the numerical information for each feature.

### Supplementary Note 9

The clustering support method according to Supplementary note 8, wherein
the target data is displayed by changing the style so as to simultaneously show the numerical information of two or more features.

### Supplementary Note 10

A program storage medium storing a clustering support program for causing a computer to execute:
a classification process for generating multiple clusters by classifying target data through machine learning; and
a display process for displaying the target data included in the generated clusters in a predetermined style at a corresponding position on a graph according to feature of the target data,
wherein, in the display process, the display style in which the target data is displayed on the graph is changed according to the numerical information for each feature.

### Supplementary Note 11

The program storage medium storing the clustering support program according to Supplementary note 10, wherein
the target data is displayed by changing the style so as to simultaneously show the numerical information of two or more features.

### Supplementary Note 12

A clustering support program for causing a computer to execute:
a classification process for generating multiple clusters by classifying target data through machine learning; and
a display process for displaying the target data included in the generated clusters in a predetermined style at a corresponding position on a graph according to feature of the target data,
wherein, in the display process, the display style in which the target data is displayed on the graph is changed according to the numerical information for each feature.

### Supplementary Note 13

The clustering support program according to Supplementary note 12, wherein
the target data is displayed by changing the style so as to simultaneously show the numerical information of two or more features.

The above description of the present invention is with reference to the example embodiments, but the present invention is not limited to the above example embodiments.

Various changes can be made to the composition and details of the present invention that can be understood by those skilled in the art within the scope of the present invention.

### REFERENCE SIGNS LIST

1 Clustering support system
10 Data acquisition unit
20 Related information acquisition unit
30 Object identification unit
40 Data processing unit
50 Text information input unit
60 Feature extraction unit
70 Feature storage unit
80 Visualization processing unit
90 Input/output device

What is claimed is:

1. A clustering support system comprising:
a memory storing instructions; and
one or more processors configured to execute the instructions to:
generate multiple clusters by classifying target data through machine learning; and
display the target data included in the generated clusters in a predetermined style at a corresponding position on a graph according to feature of the target data; and
change the style in which the target data is displayed on the graph according to the numerical information for each feature.

2. The clustering support system according to claim 1, wherein the processor is configured to execute the instructions to
display the target data by changing the style so as to simultaneously show the numerical information of two or more features.

3. The clustering support system according to claim 2, wherein the processor is configured to execute the instructions to
overlap colors indicated by the numerical information of each feature and display mixed colors.

4. The clustering support system according to claim 1, wherein the processor is configured to execute the instructions to
change shading density or brightness of the style according to the numerical information.

5. The clustering support system according to claim 1, wherein the processor is configured to execute the instructions to
recalculate statistical quantities of the target data for a specified range on the displayed graph and change the style in which the target data in the specified range is displayed on the graph according to the recalculated statistical quantities.

6. The clustering support system according to claim 1, wherein the processor is configured to execute the instructions to
display the target data by changing the style of the feature based on correlation between specified features.

7. The clustering support system according to claim 1, wherein the processor is configured to execute the instructions to
display the target data on the graph by performing dimensional reduction.

8. A clustering support method comprising:
generating multiple clusters by classifying target data through machine learning; and
displaying the target data included in the generated clusters in a predetermined style at a corresponding position on a graph according to feature of the target data,
wherein, in displaying the target, the display style in which the target data is displayed on the graph is changed according to the numerical information for each feature.

9. The clustering support method according to claim 8, wherein
the target data is displayed by changing the style so as to simultaneously show the numerical information of two or more features.

10. A non-transitory computer readable information recording medium storing a clustering support program, when executed by a processor, that performs a method for:
generating multiple clusters by classifying target data through machine learning; and
displaying the target data included in the generated clusters in a predetermined style at a corresponding position on a graph according to feature of the target data,
wherein, in displaying the target, the display style in which the target data is displayed on the graph is changed according to the numerical information for each feature.

11. The non-transitory computer readable information recording medium according to claim 10, wherein
the target data is displayed by changing the style so as to simultaneously show the numerical information of two or more features.
